(19) United States
(12) Patent Application Publication
(10) Pub. No.: US 2025/0262498 A1
(43) Pub. Date: Aug. 21, 2025

(54) The Remote Controlled Basketball Goal Lift Cabinet

(71) Applicant: Carla Michelle Goodman, Fredericksburg, VA (US)

(72) Inventor: Carla Michelle Goodman, Fredericksburg, VA (US)

(21) Appl. No.: 18/444,701

(22) Filed: Feb. 18, 2024

(51) Int. Cl. A63B 63/08; F21S 9/03; F21Y 113/13; F21Y 115/10

(52) U.S. Cl. CPC A63B 63/083; F21S 9/037; A63B 2210/56; F21Y 2113/13; F21Y 2115/10

(57) ABSTRACT

The Remote-Controlled Basketball Goal Lift Cabinet represents an innovative solution in the realm of basketball equipment management, offering a comprehensive system for retracting and storing basketball goal with efficiency and convenience. Designed with meticulous attention to detail, this basketball goal system features a Storage Cabinet equipped with two outward-opening doors and ample space for storing up to two standard-sized basketballs, along with additional equipment. Enhanced with two LED solar panels atop the cabinet, the system provides optimal visibility during low-light conditions, ensuring uninterrupted gameplay. With adjustable height settings controlled by a remote, an integrated ball return mechanism, and intuitive operation via remote control, this system offers unparalleled versatility and user-friendly functionality. The incorporation of durable construction materials and thoughtful design elements further underscores its reliability and durability, making it an indispensable asset for basketball enthusiasts and professionals alike.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present invention pertains to basketball equipment, specifically focusing on an automatic storage cabinet designed to retract and store basketball goal. This system enables the storage of two basketballs and features two LED solar panels positioned on top. These panels emit light towards the basketball goal, enhancing visibility during play in low-light conditions.

### Description of the Related Art

Basketball, a popular sport worldwide, is characterized by its fast-paced gameplay and dynamic nature. Played by teams of five players each, the objective is to score points by shooting the ball through the opponent's hoop, which is elevated at a height of 10 feet above the ground. The game demands athleticism, teamwork, and strategic thinking, making it a favorite among players and fans alike. Basketball has evolved over the years, with various modifications to rules, equipment, and playing surfaces, but its fundamental principles of shooting, dribbling, and passing remain unchanged.

Basketball goals, also known as hoops, are pivotal components of the game, serving as the target for players to score points. Traditionally made of metal, these goals consist of a circular rim attached to a backboard, which is typically made of transparent or opaque material. The rim is equipped with a net to catch the ball after a successful shot. Modern basketball goals may feature adjustable height mechanisms to accommodate different age groups and skill levels, ensuring inclusivity and accessibility in recreational and competitive settings.

Basketball storage devices play a crucial role in organizing and maintaining equipment for practices, games, and tournaments. These storage solutions are designed to securely hold basketballs, hoops, nets, and other accessories, ensuring easy access and efficient retrieval when needed. Common types of basketball storage devices include storage cabinets, equipment racks, and portable carts, each tailored to meet specific needs and space requirements. These devices contribute to the overall organization and functionality of basketball facilities, enhancing the playing experience for athletes and coaches.

Despite their utility, traditional basketball goal storage devices often suffer from shortcomings that can hinder their effectiveness. One common issue faced by individuals who own outdoor portable basketball goals is storage. Currently, many of these owners struggle with the lack of adequate storage solutions when the weather conditions are unfavorable for outdoor play. As a result, these basketball goals often end up lying on the ground in the yard, detracting from the aesthetics of the property and creating an eyesore. Alternatively, they may remain exposed to the elements, leading to weather damage and deterioration over time. However, with the introduction of the Remote-Controlled Basketball Goal Lift Cabinet, this problem is effectively resolved. This innovative solution allows users to retract the basketball goal and store it securely within the cabinet. By utilizing remote control functionality, the goal can be effortlessly lifted and rolled inside, providing protection from adverse weather conditions and preserving its longevity. Ultimately, this not only improves the appearance of the property but also saves money for the consumer by prolonging the lifespan of their basketball goal.

Below are the patents related to patents related to basketball storage devices. A US patent titled “Basketball equipment rack” bearing U.S. Pat. No. 6,575,642B2 discusses an equipment rack designed specifically for organizing and storing basketballs, basketball hoops, nets, and other related accessories.

Another US patent, titled “Portable basketball storage cart” with U.S. Pat. No. 8,322,745B2, describes a portable storage cart intended for transporting and storing basketballs, hoops, and other equipment.

A patent application, published as US20190306923A1, reveals a basketball equipment storage cabinet featuring adjustable shelves, hooks, and compartments to accommodate various basketball equipment items, such as basketballs, hoops, jerseys, and shoes.

Moreover, a patent application with publication number US20190277542A1 unveils a basketball storage bag equipped with a built-in rack system for organizing and storing basketballs. The bag includes straps or handles for easy carrying and a collapsible or expandable rack system for efficient storage and transportation.

The current invention aims to provide a need in the field of basketball equipment by introducing an innovative automatic storage cabinet designed specifically to retract and store basketball goal. This system offers a convenient solution for efficiently managing basketball equipment, particularly in spaces where storage space is limited. By incorporating automated retractable mechanisms, the cabinet allows basketball goal to be easily stowed away when not in use, maximizing available space and minimizing clutter in storage areas.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel form of remote-controlled basketball goal storage device.

The main objective of the invention is to provide an improved assembled Basketball Goal with enhanced storage capacity. The Remote-Controlled Basketball Goal Lift Cabinet offers ample storage space within its Storage Cabinet, accommodating up to two standard-sized basketballs along with additional basketball equipment.

It is further the objective of the invention to provide Convenient Mobility: Equipped with wheels and a pull handle, the cabinet provides effortless mobility, allowing users to easily transport it to desired locations. The wheel stop mechanism ensures stability when stationary, providing added convenience and flexibility in setting up the basketball goal.

It is the objective of the invention to enable adjustable goal height using the Retractable Pole, allowing users to customize the height of the basketball goal to three different settings using a remote control. This versatility caters to players' preferences and varying skill levels, enhancing the overall playing experience.

It is the objective of the invention to introduce an innovative ball return mechanism within the Basketball Rim, eliminating the need for manual retrieval of the ball by automatically guiding it back to the shooter when it goes through the rim. This feature promotes continuous play and skill development.

It is the objective of the invention to facilitate remote-controlled operation through the inclusion of a remote control, allowing users to effortlessly lift and lower the basketball goal, turn the LED solar lights on and off, and control the Ball Return mechanism. This intuitive functionality enhances user convenience and ease of operation.

It is the objective of the invention to enhance visibility during play in low-light conditions with the integration of Solar LED Lights into the cabinet's top surface, providing illumination in three different colors. This feature ensures optimal gameplay quality and safety regardless of environmental lighting conditions.

It is the objective of the invention to enable solo play capability with the Basketball Return Lever, guiding the ball back to the shooter after it goes through the rim. Controlled by the remote control, this mechanism facilitates solo practice sessions and skill refinement, enhancing player performance and development.

It is the objective of the invention to ensure durability and longevity with the construction of sturdy components such as the Pull Handle, Storage Cabinet Doors with Knobs, and Cabinet Wheels. These components contribute to the overall robustness of the Basketball Goal Lift Cabinet, withstanding rigorous use over time.

It is the objective of the invention to provide secure stability during gameplay with the inclusion of lever-operated wheel locks on the Cabinet Wheels. This feature prevents unwanted movement, ensuring safety and consistency in performance during intense gameplay sessions.

It is the objective of the invention to offer versatile weight attachment options with the Detachable Water/Sand Holder Weight, providing flexibility in stabilizing the basketball goal during play. This easily attachable and detachable weight can be filled with water or sand, offering convenient storage and deployment options within the Storage Cabinet.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 shows a basketball equipment storage system incorporating the embodiments of the invention.

FIG. 2 shows the basketball equipment storage system incorporating the embodiments of the invention.

FIG. 3 shows the basketball equipment storage system incorporating the embodiments of the invention.

FIG. 4 shows a Detachable Water/Sand Holder Weight attached to the lower back side of the Basketball Goal Cabinet, holding water or sand to stabilize the Basketball Goal during play, the Detachable Water/Sand Holder Weight is removable and can be stored within the Storage Cabinet when not in use.

FIG. 5 shows Remote Control device operable to lift and lower the basketball goal, control the LED solar lights, and activate the Ball Return mechanism.

FIG. 6 shows how the rim raises for storage incorporating the embodiments of the invention.

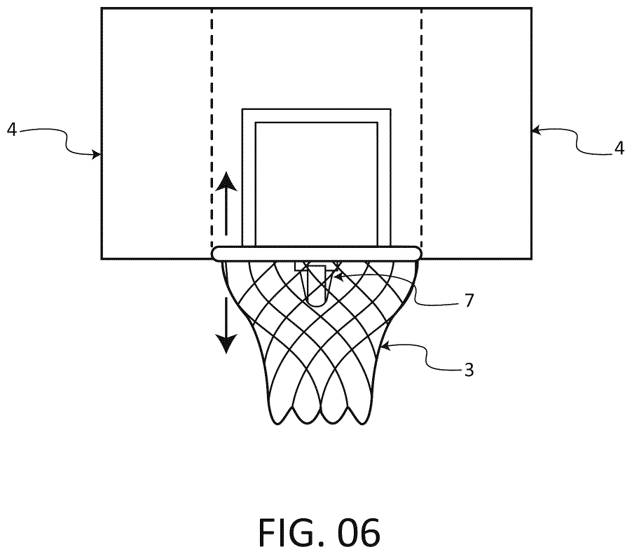

FIG. 7 shows the complete mechanism as per preferred embodiments of the invention.

The apparatus and method components have been represented where appropriate by conventional symbols in the drawings, showing only those specific details

### SPECIFICATIONS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Although described with particular reference to basketball, those with skill in the arts will recognize that the disclosed embodiments have relevance to adaptations of basketball in addition to those specific examples described below.

All references, including publications, patent applications, and patents, cited herein are hereby incorporated by reference to the same extent as if each reference were individually and specifically indicated to be incorporated by reference and were set forth in its entirety herein.

The present invention is directed to a remote-controlled operated assembly used to store basketball goal. As per preferred embodiments of the invention, the Remote-Controlled Basketball Goal Lift Cabinet is meticulously designed to address various needs and challenges encountered in the management of basketball equipment. The cabinet features a Storage Cabinet, strategically positioned to retract and store the basketball goal when not in use. Equipped with two doors on the front panel that open outwards, this cabinet offers ample storage space for up to two standard-sized basketballs, along with additional basketball equipment. The inclusion of two LED solar panels on top of the cabinet provides enhanced functionality by illuminating the basketball goal during play when natural lighting is limited, ensuring optimal visibility for players.

As per preferred embodiments of the invention, the Retractable Pole serves as a pivotal component of the basketball goal lift cabinet, enabling smooth lowering and extension of the basketball goal into and out of the cabinet. This innovative feature allows users to raise the basketball goal to three separate heights, all controlled conveniently via remote control. The adjustable height settings cater to players' preferences and varying skill levels, enhancing the versatility and adaptability of the basketball goal for different gameplay scenarios.

As per preferred embodiments of the invention, the Basketball Rim with Net is meticulously crafted to meet performance and safety standards. With a diameter of approximately 18 inches, the rim is made of a solid rod with a diameter of approximately ⅝ inches, ensuring durability and stability during gameplay. The integrated mechanism beneath the rim guides the ball back to the shooter automatically, promoting continuous play and skill development. Additionally, the net attached to the rim tapers down towards the bottom, effectively slowing down the motion of the ball without stopping it fully, contributing to a seamless gameplay experience.

As per preferred embodiments of the invention, the Backboard is designed for functionality and convenience. Comprising three pieces of flat rigid material, the backboard provides a stable surface to which the basketball rim is attached. To optimize storage space when not in use, the two end pieces of the backboard fold inward, allowing the backboard to be lowered into the storage cabinet effortlessly. This innovative design ensures efficient utilization of space and easy retrieval of equipment, enhancing the overall user experience.

As per preferred embodiments of the invention, the Remote Control offers intuitive and convenient operation of the basketball goal lift cabinet. With the remote control, users can effortlessly lift and lower the basketball goal, toggle the LED solar lights on and off, and control the Ball Return mechanism. This user-friendly interface enhances user convenience and allows for seamless control of the basketball goal lift cabinet during gameplay.

As per preferred embodiments of the invention, the Solar LED Lights integrated into the cabinet's top surface provide illumination in three different colors, enhancing visibility during play in low-light conditions. These lights are controlled via the remote control, allowing users to adjust the lighting settings to suit their preferences and gameplay needs. The illumination provided by the solar LED lights ensures optimal gameplay quality and safety, regardless of environmental lighting conditions, contributing to an enhanced playing experience for athletes and enthusiasts alike.

As per preferred embodiments of the invention, the Basketball Return Lever enables solo play capability and skill refinement. Controlled by the remote control, this mechanism guides the ball back to the shooter after it goes through the rim, eliminating the need for manual retrieval and facilitating continuous practice sessions. The lever's spring mechanism allows for smooth movement, ensuring consistent and reliable performance during solo play sessions. Overall, the combination of innovative features and user-friendly design elements makes the Remote-Controlled Basketball Goal Lift Cabinet a versatile and indispensable tool for basketball enthusiasts and professionals alike.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

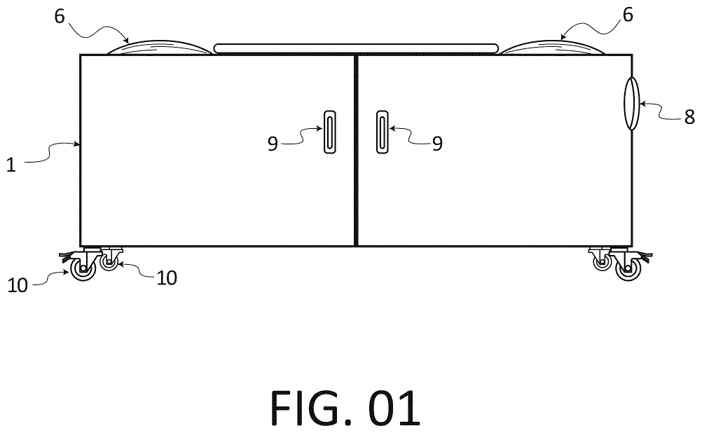

1. As per claim 1 FIG. 1 shows, a basketball equipment storage system comprising:
a Storage Cabinet configured to retract and store a basketball goal;
two doors on a front panel of the Storage Cabinet, the doors opening outwards;
a front space within the Storage Cabinet for storing up to two standard-sized basketballs and additional basketball equipment;
two LED solar panels positioned on top of the Storage Cabinet, emitting light towards the basketball goal for enhanced visibility during play in low-light conditions.

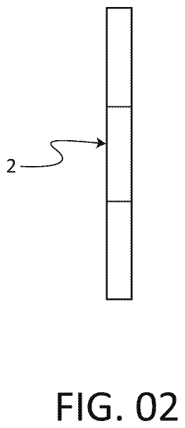

2. As per claim 2 FIG. 2 shows, the basketball equipment storage system of claim 1 further comprising:
a Retractable Pole configured to lower and extend the basketball goal into and out of the Storage Cabinet;
a remote control device operable to adjust the height of the basketball goal using the Retractable Pole to three separate settings;
wherein the Retractable Pole is configured to smoothly lower and extend the basketball goal into and out of the Storage Cabinet, minimizing wear and tear on the equipment.

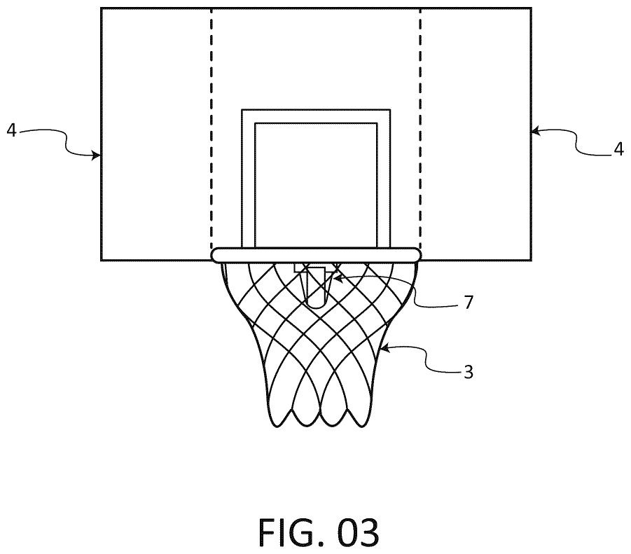

3. As per claim 3 FIG. 3 shows, the basketball equipment storage system of claim 1 further comprising:
a Basketball Rim, having a diameter of approximately 18 inches and a solid rod with a diameter of approximately ⅝ inches;
a net attached to the Basketball Rim, tapering down towards the bottom to slow down the motion of the ball without stopping it fully;
the Basketball Rim lifts up allowing the backboard to fold inward for storage.

4. As per claim 4 FIG. 3 shows, the basketball equipment storage system of claim 1 further comprising:
Backboard comprising three pieces of flat rigid material, with two end pieces to be folded inward to allow the Backboard to be lowered into the Storage Cabinet when not in use.

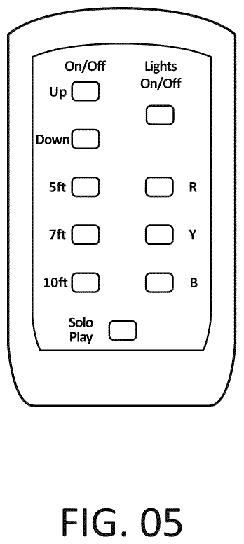

5. As per claim 5 FIG. 5 shows, the basketball equipment storage system of claim 1 further comprising:
a Remote Control device operable to lift and lower the basketball goal, control the LED solar lights, and activate the Ball Return mechanism.

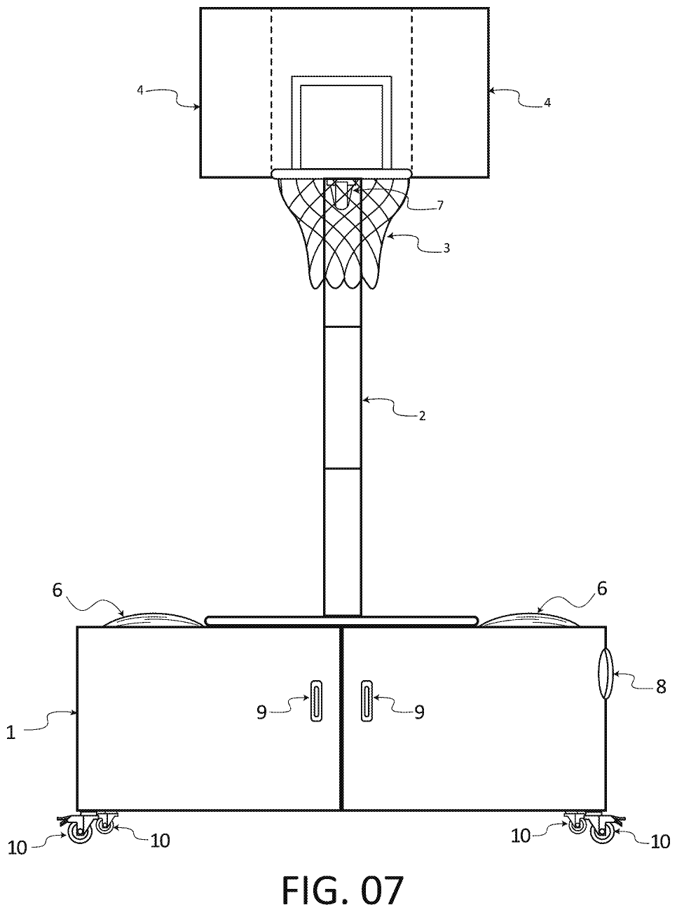

6. As per claim 6 FIG. 7 shows, the basketball equipment storage system of claim 1 further comprising:
Solar LED Lights positioned on top of the Storage Cabinet, illuminating in three different colors and controlled by the Remote Control device.

7. As per claim 7 FIG. 7 shows, the basketball equipment storage system of claim 1 further comprising:
a Basketball Return Lever located under the center of the Rim, operable to guide a ball back to a shooter when activated by the Remote Control device.

8. As per claim 8 FIG. 7 shows, the basketball equipment storage system of claim 1 further comprising:
a Pull Handle mechanism located on the side of the Cabinet, facilitating movement of the Storage Cabinet.

9. As per claim 9 FIG. 7 shows, the basketball equipment storage system of claim 1 further comprising:
Storage Cabinet Doors equipped with knobs for opening and closing the doors located on the front panel of the Storage Cabinet.

10. As per claim 10 FIG. 7 shows, the basketball equipment storage system of claim 1 further comprising:
Cabinet Wheels approximately 3 inches in diameter, facilitating movement of the Storage Cabinet, with lever-operated wheel locks to prevent unwanted movement;
wherein the Storage Cabinet is equipped with a wheel stop mechanism to ensure stability when the Storage Cabinet is stationary, providing safety and consistency during gameplay.

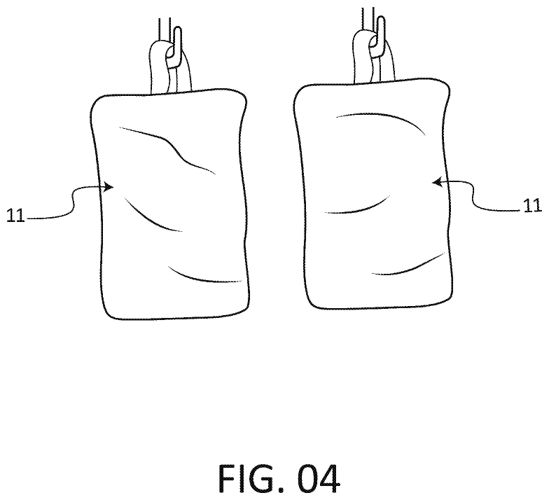

11. As per claim 11 FIG. 4 shows, the basketball equipment storage system of claim 1 further comprising:
a Detachable Water/Sand Holder Weight attached to the lower back side of the Basketball Goal Cabinet, holding water or sand to stabilize the Basketball Goal during play, the Detachable Water/Sand Holder Weight is removable and can be stored within the Storage Cabinet when not in use.
